(19) United States
(12) Patent Application Publication
(10) Pub. No.: US 2014/0049428 A1
(43) Pub. Date: Feb. 20, 2014

(54) DIRECTIONAL RADIO SIGNAL DETECTION APPARATUS USING A SENSE AND LOOP ANTENNAS

(71) Applicant: Son Nguyen, Westminster, CO (US)

(72) Inventor: Son Nguyen, Westminster, CO (US)

(21) Appl. No.: 13/586,172

(22) Filed: Aug. 15, 2012

(51) Int. Cl. G01S 3/02

(52) U.S. Cl. 342/448

(57) ABSTRACT

An apparatus for direction finding a received radio signal is enclosed. The receiving apparatus selectively receives on a predetermined frequency to match the transmitter frequency. The receiving apparatus is comprised of one non directional antenna and two or more loop antennas. The loop antennas modify the field of the incident radio signal by absorbing the incident radio frequency energy to create a non-ambiguous gain pattern on the sense antenna that can be used to determine the direction of the incident RF signal.

### DESCRIPTION OF PRIOR ART

Directional radio signal detectors are used to find the direction of a radio emitting source such as a radio beacon. These directional detectors can be composed of a single antenna or multiple antennas. Direction of the signal source can be determined using phase technique, signal strength, or a combination of signal strength and phase.

In a phase measurement technique more than one antenna is used. The typical method is to spatially separate the multiple antennas and to measure the difference in time of arrival or equivalently, the phase difference of the signal between the antennas. Other methods utilize a change in the phase of the signal on an antenna depending on the direction of the signal source. These other phase based systems have circuits that sum, difference and/or multiply the antenna signals. The phase information between the antennas is then used to determine the direction of the signal source. Phase based systems typically automatically determine the direction of the signal and do not require the user to interpret a signal strength nor require the rotation of the antenna.

The signal strength approach relies on the characteristic of an antenna or antennas where the signal strength varies depending on the incident angle on the antenna or antennas. Some examples of directional antennas include loops, Yagi and Quad antennas. Loop antennas are often used because they are easy to build and can have deep signal strength nulls resulting in good directional accuracy. A loop antenna has a symmetric response so the direction of the signal has an ambiguity of 180 degrees. Yagis and Quads are multi-element antennas with reflector and director antennas. Yagi and Quad antennas have good directionality but are relatively large because they have additional elements to create the beam pattern. The distance between the elements is typically around ¼ of a wavelength and the elements' sizes are around ½ of a electrical wavelength.

Directional antennas have been made by combining two different types of antennas. A single loop antenna has been combined with a dipole or monopole sense antenna to eliminate the symmetrical beam pattern and/or to increase the sensitivity of the antenna system by utilizing the directionality of the loop antennas.

Two loop antennas have been combined with a third non-directional antenna using a phase approach for direction finding. For example, the following patents all utilize a phase based approach to direction finding:
U.S. Pat. No. 4,489,327 to Eastwell;
U.S. Pat. No. 4,307,402 to Watanabe;
U.S. Pat. No. 3,967,280 to Mayer et al.; and
U.S. Pat. No. 4,121,216 to Bunch.

### SUMMARY OF THE INVENTION

A method that has not been used in the art is to use more than one loop antenna with a normally non-directional antenna to create a field pattern on the non-directional antenna useable for direction finding. The non-directional antenna can include a dipole, monopole, helical or other antenna which, when used by itself in the proper orientation relative to the incident RF, shows no directionality. The term sense antenna, used in this document refers to a normally non-directional antenna, which may attain a field pattern that is useful for detecting the direction of an RF signal. The concept of using the loop antennas is to change the amount of signal received on the sense antenna based on the orientation of the apparatus relative to the incident RF, creating a non-ambiguous field pattern on the sense antenna.

The use of loop antennas in combination with a sense antenna has a number of advantages. The physical size of loop antennas can be made small relative to a typical non-directional antenna by using small to medium loop antennas. A small loop antenna is defined herein as an antenna where the total conductor length is less than 0.1 wavelength. A medium loop antenna is an antenna where the total conductor length greater than 0.1 wavelength and less than 1 wavelength. Compared to Yagis or Quads, where the geometry and size of the antennas are dictated by the frequency and are often very large and bulky, the invention described herein can be made much more compact and portable. The antennas can be placed very close together, less than 0.05 wavelengths.

A dual loop with sense antenna would require less complicated circuitry compared to a phase based system, since a phase based system needs summing, difference and/or multiplication circuits while the present invention describe herein would only need a means to measure the signal strength of the sense antenna.

The use of multiple loop antennas allows for the creation of field patterns not possible with a single loop antenna, due to the fact that multiple loop antennas increase the degrees of freedom. The available parameters include loop antenna size, spacing and location, and loop antenna angle relative to the other antennas.

When compared to phase based systems utilizing loop antennas, a system utilizing the invention described herein may have significantly better range. The overall sensitivity of the phase based system is dependent on all the antennas. Thus a phase based system's sensitivity is only as good as the least sensitive antenna Small and medium loop antennas often used in phase based systems do not have the same sensitivity as the typical sense antennas used in these systems. The apparatus described herein obtains the directional signal from the sense antenna.

In certain phased based implementation where two loop antennas and a sense antenna are used, and the antennas are properly configured, the signal strength method described herein may be used in conjunction with the phase method. By allowing phase and signal strength to be used in one system, the advantage of a phase technique (accuracy) and the advantage of a signal strength technique (range) can be combined to provide a much more useful apparatus. At long range where small or medium loop antennas are not useable due to their low sensitivity the signal strength method described herein can be used. Once the distance from the apparatus to the signal source is close enough where the loop antennas are useable the phase method can be used for better accuracy and ease of use.

Typically only small and one wavelength antennas are used for direction finding because the deep nulls in their response are useful in direction finding. Since the method described herein does not depend on the deep nulls in the loop antenna response, medium loop antennas can be utilized. The advantages of medium loop antenna are that it is more sensitive than a small loop antenna and it is smaller than a one wavelength loop antenna making it more portable and easier to implement.

### BRIEF DESCRIPTION OF THE DRAWINGS

FIG. 1A depicts a loop antenna, the electric and magnetic fields of the incident RF and theta (θ) is the angle of the loop antenna relative to the incident RF signal. The antenna loop windings are in the Z and Y axes.

FIG. 1B depicts the gain pattern of a small loop antenna. A small loop antenna responds primarily to the magnetic field, \vec{H}, and thus the antenna response is highest when the antenna orientation is such that the axis around which the loop is wound is parallel to the direction of the incident RF signal.

FIG. 1C depicts the gain pattern of a one wavelength loop antenna. A one wavelength loop antenna responds primarily to the electric field, \vec{E}, and thus the antenna response is highest when the antenna orientation is such that the axis around which the loop is wound is perpendicular to the incident RF signal.

FIG. 1D depicts the gain pattern of a medium loop antenna. A medium loop antenna gain pattern will be a combination of a small loop antenna gain pattern and a one wavelength loop antenna gain pattern because it will respond to both the electric field, \vec{E}, and magnetic field, \vec{H}.

FIG. 2 depicts the various loop antenna gain responses from a small loop antenna to a one wavelength loop antenna. A small loop antenna is plotted as line “1” while a one wavelength antenna is plotted as line “0”. The x axis depicts the angle of the axis around which the loop antenna is wound relative to the direction of the incident RF signal while the y axis the relative sensitivity. At angles +90 degrees and −90 degrees, the axis around which the loop antenna is wound is parallel to incident RF signal. At an angle of 0 degrees, the axis around which the loop antenna is wound is perpendicular to the incident RF signal.

FIG. 3 depicts an embodiment of an antenna arrangement for two medium loop antennas and a sense antenna shown from a top view perspective.

FIG. 4 depicts the loop antenna gain response of a medium loop antenna in the antenna arrangement in FIG. 3.

FIG. 5 depicts an example of a response of the sense antenna of a system shown in FIG. 3.

FIG. 6 depicts an embodiment of an antenna arrangement for two small loop antennas and a sense antenna shown from a top view perspective.

FIG. 7 depicts an embodiment of an antenna arrangement for two one wavelength loop antennas and a sense antenna shown from a top view perspective.

### DETAILED DESCRIPTION

The present disclosure consists of a non-directional antenna such as a dipole, helical or monopole antenna referred as the sense antenna and two or more loop antennas. Using the loop antennas to absorb the energy, a non-ambiguous antenna response on the sense antenna can be created.

A dipole, monopole or helical antenna oriented in the z direction has a gain pattern which is uniform in the x and y axis. Thus a signal coming from any direction in the x-y plane will result in the same signal level. A loop antenna is directional and has symmetrical gain pattern.

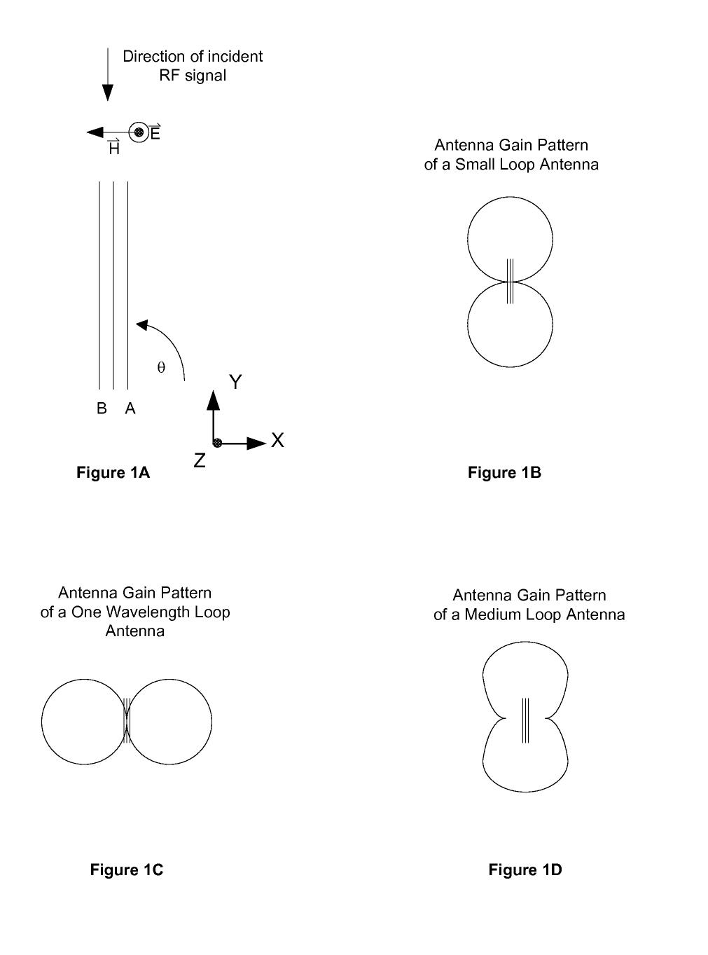

FIG. 1A shows a loop antenna wound in the Y and Z plane with Theta (θ), the angle of the loop antenna relative to the incident RF. The bean pattern of a small loop antenna is shown in FIG. 1B and can be characterized by the equations:

0°<θ<180° |sinθ|sin(ωt)

180°<θ<360° −|sinθ|sin(ωt)

FIG. 1C shows the beam pattern of a one wavelength antenna and its response can be characterized by the equation:

|cosθ|cos(ωt)

Note that the beam pattern of a small verses a one wavelength loop antenna is 90 degrees offset.

A medium loop antenna response can be characterized as the summation of the one wavelength loop and small loop antenna responses and can be approximated by the equations:

0°<θ<180° |Asinθ|sin(ωt)+C|(1−A)cosθ|cos(ωt)

180°<θ<360° −|Asinθ|sin(ωt)+C|(1−A)cosθ|cos(ωt)

where 0≦A≦1

A is a factor that describes the medium loop response to the magnetic field vs. the electric field. C is the power ratio between a one wavelength loop antenna and a small loop antenna. This factor is to account for the fact that a one wavelength loop antenna typically has better sensitivity over a small loop antenna. Using trigonometric identities, the equation for the medium loop antenna above can be represented by the following equations:

({square root over ((A sinθ)²+C²(1−A)² cos²θ))}(sin(ωt+φ))

where φ is the phase response of the medium loop antenna.

$$ϕ = {sin}^{- 1} ( \frac{\vert ( 1 - A ) cos θ \vert}{\sqrt{{( A sin θ )}^{2} + {( 1 - A )}^{2} {cos}^{2} θ}} ) 0 ° < θ < 180 °$$

$$ϕ = π - {sin}^{- 1} ( \frac{\vert ( 1 - A ) cos θ \vert}{\sqrt{{( A sin θ )}^{2} + {( 1 - A )}^{2} {cos}^{2} θ}} ) 180 ° < θ < 360 °$$

FIG. 1D shows the antenna gain pattern of a medium loop antenna. Because the medium loop antenna responds to both the magnetic field \vec{H} and the electric field \vec{E}, the response of the medium loop antenna will have a gain pattern that is a combination of a small and a one wavelength antenna depending on the length of the antenna winding.

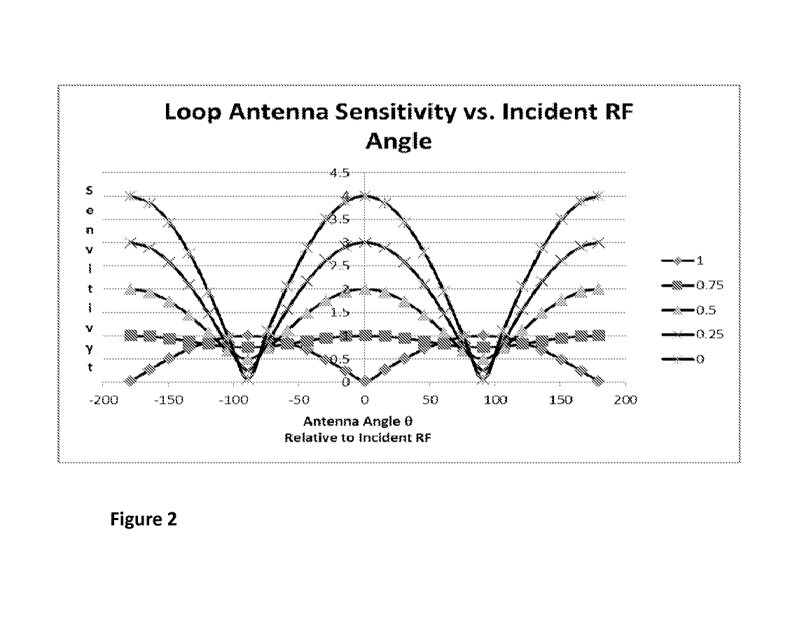

FIG. 2 shows an example of a loop antenna response for various values of A between 1 (a small loop antenna), and 0 (a one wavelength loop antenna) and a C value of 4. In this case, the plot characterizes an antenna where a one wavelength antenna has four times the sensitivity of a small loop antenna.

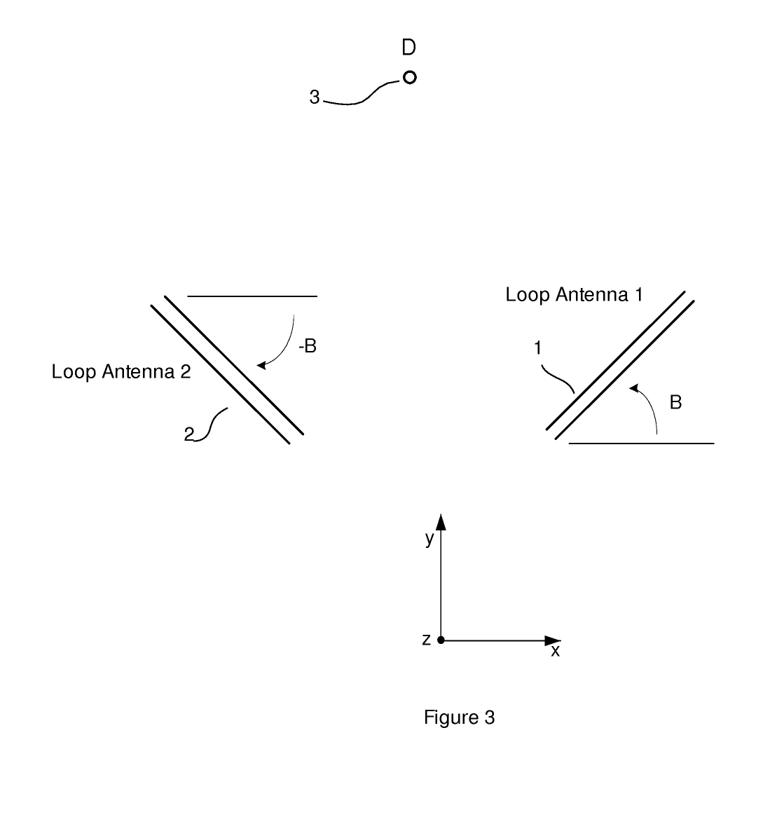

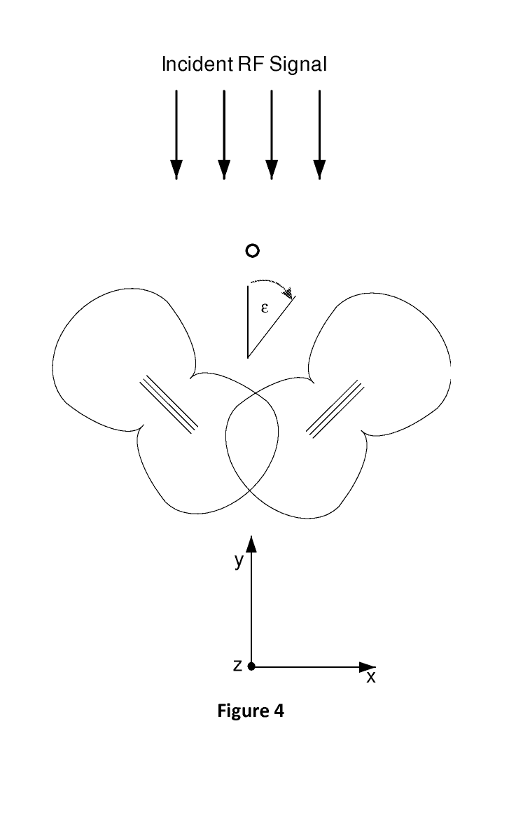

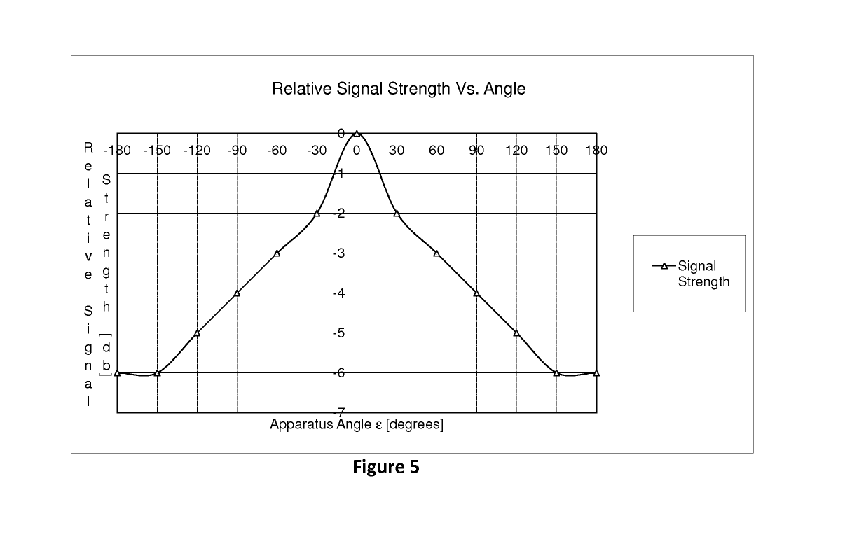

FIG. 3 shows the antenna arrangement of one embodiment using two loop antennas and a dipole antenna. The two loop antennas, 1 and 2 are arranged at an angle B and −B and symmetrical relative to the dipole antenna 3. B in this example is 45 degrees. The loop antennas are tuned to the receiving frequency so that they absorb the energy at the receive frequency. FIG. 4 shows the antenna gain pattern of a medium loop antennas superimposed on the loop antennas in the antenna configuration shown in FIG. 3. Symbol, ε or epsilon is angle of the apparatus relative to the incident RF. When ε is zero degrees, the incident RF signal reaches the sense antenna first. At some larger angles of ε, some of the incident RF energy reaches the loop antennas first and is absorbed. The energy reaching the sense antenna then is less than the energy reaching the sense antenna when the angle, ε, is zero. The amount of energy absorbed by the loop antennas depend on the size of the loop antennas, the orientation of the loop antennas and the distance of the antennas from each other and from the sense antenna. Any interactions between the antennas may enhance or reduce the directionality of the sense antenna. FIG. 5 shows an example of the response of the sense antenna of an antenna system arranged as shown in FIG. 3. The y axis is the relative antenna signal level in dB while the x axis is the angle or rotation of the apparatus relative to the incident RF signal.

Reducing the interactions between the antennas allows for easier modeling of the response, realization and/or reduction in overall size of the system. Two much interactions between the antennas can result in the antenna system behaving as one antenna, with little or no directivity or make it very difficult to adjust the response. The advantage in using a small or medium loop antenna is not only its small size relative to a dipole or other typical sense antenna. Because they respond primarily or partially to the magnetic field, small and medium loop antennas can be placed closer to the sense antenna with minimal interaction between the loop and sense antenna. By knowing the field pattern of the loop antennas, the loop antennas can be arranged in such a manner as to create a directional antenna pattern on the reference antenna. The loop antennas can be made smaller or larger as necessary to absorb more or less energy or to create different patterns.

A rule of thumb is that the physical dimension of an antenna approximates the near field pattern that the antenna will create. A physically smaller antenna will create a smaller interaction field. Thus loop antennas that are small allow for closer arrangement due to its size. Positioning the loop antennas so that they are not parallel to each other also reduces the interactions between the two loop antennas. A practical system has been developed where the antennas are spaced as close as 0.05 wavelengths without significant interactions between the loop and sense antenna.

To find the direction of the radio signal source in the x-y plane, the apparatus is rotated in the x-y plane or around the azimuth. Using the signal strength, the direction of the incident RF is determined. The maximum signal strength typically would be used to determine the direction to the source, but alternatively, the minimal signal strength may be used in conjunction with the maximum signal strength or they may be independently used as well.

More than two loop antennas can be utilized but typically not required unless the additional antennas are needed for additional beam shaping not achievable with two loop antennas.

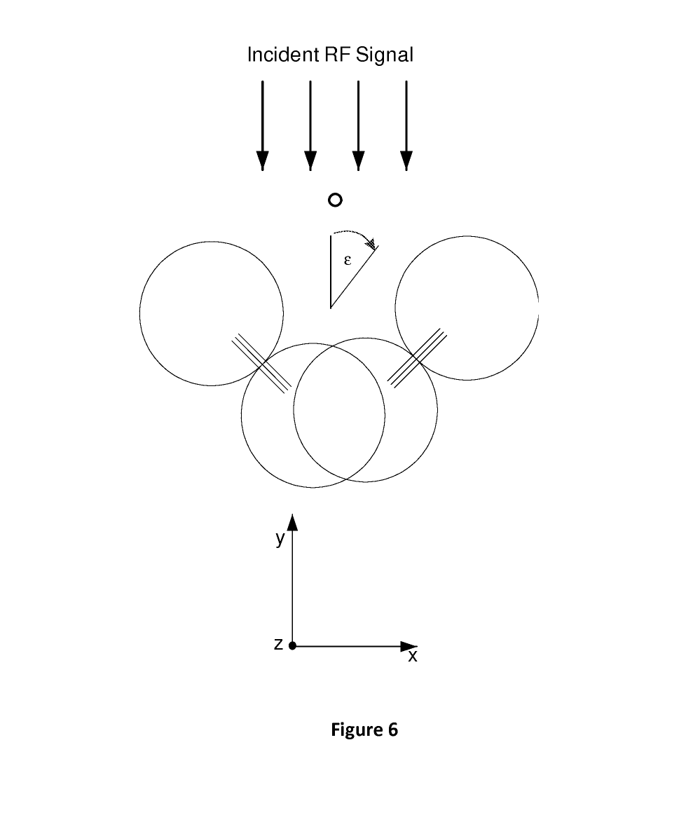

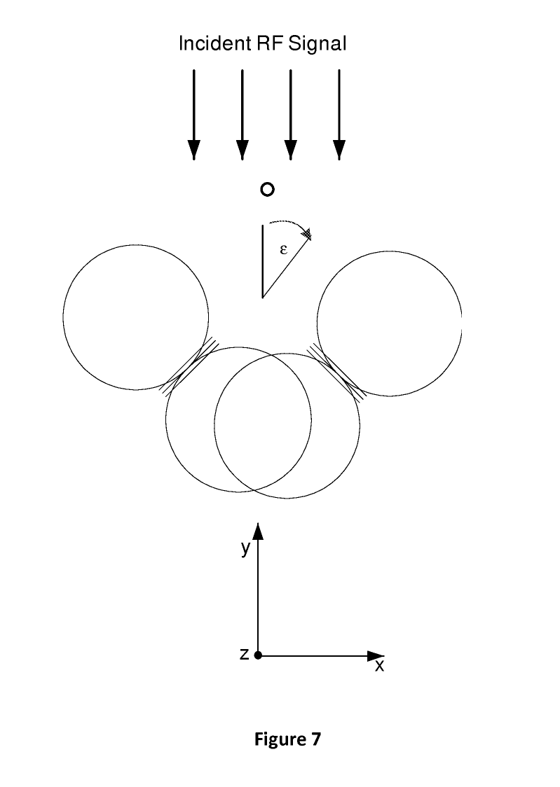

FIG. 6 and FIG. 7 depicts the same antenna arrangement as in FIG. 3 with the antenna gain pattern for small and one wavelength loop antennas respectively. As shown, with proper antenna spacing and geometry, it would be easy to prevent a situation where the incident RF goes through the null point of the loop antennas and creating an angle where the signal strength on the sense antenna is ambiguous. In addition, interactions between the loop antennas tend to reduce the nulls in the loop antennas.

What is claimed is:

1. An apparatus for determining the bearing angle with respect to said apparatus to a transmitter emitting a predetermined radio signal, comprising:
a sense antenna adapted to be responsive to said predetermined radio signal, said sense antenna capable of supplying a output signal upon interaction with said predetermined radio signal,
wherein said sense antenna is adapted such that the sensitivity of said sense antenna does not vary substantially when said sense antenna is rotated in a plane intersecting said predetermined radio signal;
a first loop antenna adapted to be responsive to said predetermined radio signal, said first loop antenna capable of absorbing energy in a plane intersecting said predetermined radio signal,
a second loop antenna adapted to be responsive to said predetermined radio signal, said second loop antenna capable of absorbing energy in a plane intersecting said predetermined radio signal,

2. The apparatus of claim 1, wherein said first and second loop antennas are electrically small in size relative to a wavelength of said predetermined radio signal.

3. The apparatus of claim 1, wherein said first and second loop antennas are electrically medium in size relative to a wavelength of said predetermined radio signal.

4. The apparatus of claim 1, wherein said first and second loop antennas are electrically the size of one wavelength of said predetermined radio signal.

5. The apparatus of claim 1, so that said first and second loop antennas will be disposed close to said sense antenna such that the sensitivity of said sense antenna varies when said apparatus is rotated in a plane intersecting said predetermined radio signal;

6. The apparatus of claim 5, wherein said first and second loop antennas are electrically small in size relative to a wavelength of said predetermined radio signal.

7. The apparatus of claim 5, wherein said first and second loop antennas are electrically medium in size relative to a wavelength of said predetermined radio signal.

8. The apparatus of claim 5, wherein said first and second loop antennas are electrically the size of one wavelength of said predetermined radio signal.
